(19) United States
(12) Patent Application Publication
(10) Pub. No.: US 2026/0250214 A1
(43) Pub. Date: Aug. 27, 2026

(54) CULTIVATING METHOD FOR PROMOTING PRODUCTIVITY OF CROP

(71) Applicant: Cheng-Jen LIN, Taichung City (TW)

(72) Inventor: Cheng-Jen LIN, Taichung City (TW)

(21) Appl. No.: 19/316,116

(22) Filed: Sep. 2, 2025

(30) Foreign Application Priority Data
Feb. 26, 2025 (TW) 114107139

(51) Int. Cl. C05F 17/20; C05F 11/00

(52) U.S. Cl. CPC C05F 17/20; C05F 11/00

(57) ABSTRACT

The present disclosure provides a cultivating method for promoting productivity of a crop, which comprises the following steps: step (a): providing a fermented solution of Bacillus subtilis natto, wherein the fermented solution of Bacillus subtilis natto is obtained by placing a Bacillus subtilis natto strain into a fermentation medium and then conducting fermentation; and step (b): applying the fermented solution of Bacillus subtilis natto to a cultivated field of a crop, and then conducting cultivation of the crop. The productivity of the crop obtained by the cultivating method of the present disclosure is obviously.

### CROSS-REFERENCE TO RELATED APPLICATION

Pursuant to 35 U.S.C. § 119 (a), this application claims the benefits of the priority to Taiwan Patent Application No. 114107139, filed on Feb. 26, 2025. The contents of the prior application are incorporated herein by its entirety.

### BACKGROUND OF THE INVENTION

### 1. Field of the Invention

The present disclosure relates to a cultivating method of a crop, particularly to a cultivating method for promoting productivity of the crop.

### 2. Description of the Prior Arts

Recently, the global climate changes have intensified and caused frequent disasters such as high temperature events, floods and droughts around the world, which further damages global food supply and reserves, leading to food shortages, food price surges and causing problems such as uneven food distribution and food shortages. Particularly, developing countries or countries that rely on food imports need to be more cautious facing the challenges of the food crisis.

Food crops generally refer to a common name of edible crops such as grains, beans and tuber crops, and there are many types of food crops, such as rice, wheat, corn, soybean and other common crops; wherein rice is one of the most important food crops for the human. The cultivation and harvest of these crops need a lot of labor, and they are easily affected by a combination of factors such as land, climate or pests, and it usually takes more than several months from seeding to harvesting. Therefore, how to promote the productivity under limitations such as land, labor and time becomes the main focus in the related studies.

Taking the traditional cultivating method for rice as an example, after transplanting rice seedings to paddy fields, fertilizers (such as a nitrogen fertilizer, a phosphorus fertilizer or a potassium fertilizer, etc.) are applied to rice at different timepoints during the rice cultivating process, so as to make sure sufficient quantities of elements and nutrients required for rice growth and development are provided, which can avoid the decrease in rice productivity due to malnutrition, and achieve the goal of increasing the productivity per unit area of cultivating rice.

However, although the traditional way of fertilizing the crops can promote the productivity, the problem of insufficient food supply still cannot be solved effectively. Accordingly, there is still a need to research and develop technologies related to crop cultivation in order to further increase crop productivity, thereby providing solutions to the food crisis.

### SUMMARY OF THE INVENTION

In view of the needs in the prior art, an objective of the present disclosure is to provide a cultivating method for promoting productivity of a crop. The harvested productivity of the crop cultivated by the foresaid cultivating method are obviously higher than (such as higher than 18%) the harvested productivity of a crop cultivated by the traditional way of applying fertilizers only.

To achieve the foresaid objective, the present disclosure provides a cultivating method for promoting productivity of a crop, which comprises the following steps: step (a): providing a fermented solution of Bacillus subtilis natto, wherein the fermented solution of Bacillus subtilis natto is obtained by placing a Bacillus subtilis natto strain into a fermentation medium and then conducting fermentation; and step (b): applying the fermented solution of Bacillus subtilis natto to a cultivated field of a crop, and then conducting cultivation of the crop.

By adopting the Bacillus subtilis natto strain to conduct fermentation to obtain the fermented solution of Bacillus subtilis natto, subsequently applying the fermented solution of Bacillus subtilis natto to the cultivated field of the crop and then conducting cultivation of the crop, the harvested productivity of the crop can be promoted, and demonstrates an increment of more than 18% compared to the traditional cultivating way of applying fertilizers only.

In accordance with the present disclosure, said “Bacillus subtilis natto” may also be named “Bacillus natto”, “Bacillus subtilis subsp. natto” or “Bacillus subtilis var. natto”.

In accordance with the present disclosure, the fermented solution of Bacillus subtilis natto may be obtained by adopting known Bacillus subtilis natto strain and then conducting fermentation. For example, the Bacillus subtilis natto strain may be “Bacillus subtilis natto NTU-18” with a depository number of BCRC 80390 purchased from Bioresource Collection and Research Centre (BCRC) of Taiwan, but it is not limited thereto.

In some embodiments of the present disclosure, in the step (a), the Bacillus subtilis natto strain conducts fermentation in the fermentation medium at 25° C. to 35° C. for 5 days to 7 days, so as to obtain the fermented solution of Bacillus subtilis natto.

In some embodiments of the present disclosure, in the step (a), the fermentation medium comprises water and a fermentation substrate. The fermentation substrate may be a protein-rich material suitable for fermentation, but it is not limited thereto.

In some embodiments of the present disclosure, based on a total weight of the fermentation medium, a content of the fermentation substrate is from 3 weight percent (wt %) to 12 wt %.

In some embodiments of the present disclosure, the fermentation substrate comprises a soybean meal, a soybean, a protein powder or a combination thereof.

In some embodiments of the present disclosure, in the step (a), the Bacillus subtilis natto strain is directly added into the fermentation medium for conducting fermentation to obtain the fermented solution of Bacillus subtilis natto; and based on a total weight of the fermentation medium, a content of the Bacillus subtilis natto strain is from 0.1 wt % to 1 wt %.

In some embodiments of the present disclosure, in the step (a), the Bacillus subtilis natto strain is placed into a medium for activation to obtain a Bacillus subtilis natto solution, and then the Bacillus subtilis natto solution is placed into the fermentation medium for conducting fermentation; wherein based on a total volume of the fermentation medium, a content of the Bacillus subtilis natto solution is from 1 volume percent (vol %) to 10 vol %.

In some embodiments of the present disclosure, in the step (b), the crop comprises a rice, a corn, a wheat, a soybean or a combination thereof. In some embodiments of the present disclosure, the rice may be a paddy rice or an upland rice. Specifically, the rice variety may be Kaohsiung No. 147 or Tainan No. 11, but not limited thereto.

In some embodiments of the present disclosure, in the step (b), based on an area of the cultivated field per square meter, a usage amount of the fermented solution of Bacillus subtilis natto is from 60 milliliters (mL) to 150 mL. In some embodiments of the present disclosure, in the step (b), based on an area of the cultivated field per square meter, a used amount of the fermented solution of Bacillus subtilis natto is from 70 mL to 130 mL.

In accordance with the present disclosure, the foresaid “cultivation of the crop” in the step (b) indicates regular procedures or processes for cultivating crops known by one person skilled in the art, and comprises necessary processes that maintain the normal growth and development of crops, such as fertilizing, watering, weeding or pest controlling, but it is not limited thereto.

In some embodiments of the present disclosure, the step (b) May further comprise a step of applying a fertilizer to the cultivated field. The fertilizer may be a nitrogen fertilizer, a phosphorus fertilizer, a potassium fertilizer (such as potassium humate), an animal fertilizer (such as animal excrement) or a combination thereof, but it is not limited thereto. The fertilizer may be applied to the cultivated field before, during or after the fermented solution of Bacillus subtilis natto is applied to the cultivated field.

In some embodiments of the present disclosure, the step (b) May further comprise a step of applying a tea seed pomace to the cultivated field. The tea seed pomace may be the remaining residues after tea seed oil (Camellia oil) has been pressed and/or extracted from the seeds of the Camellia oleifera trees. The tea seed pomace is also named Camellia Oleifera seed residue, and it is usually in powder form. The tea seed pomace may be applied to the cultivated field before, during or after the fermented solution of Bacillus subtilis natto or the fertilizer is applied to the cultivated field.

In some embodiments of the present disclosure, the fertilizer may be applied to the cultivated field before, during or after the tea seed pomace is applied to the cultivated field.

In the specification, a range represented by “a lower-endpoint value to an upper-endpoint value”, if not particularly specified, indicates that the range is more than or equal to the lower-endpoint value and less than or equal to the upper-endpoint value. For example, “temperature is from 25° C. to 35° C.” indicates that temperature is “more than or equal to 25° C. and less than or equal to 35° C.”.

Other objectives, advantages and novel features of the present disclosure will become more apparent from the following detailed description when taken in conjunction with the accompanying drawings.

### BRIEF DESCRIPTION OF THE DRAWINGS

FIG. 1 is a schematic flowchart illustrating the cultivating method for promoting productivity of a crop of the present disclosure.

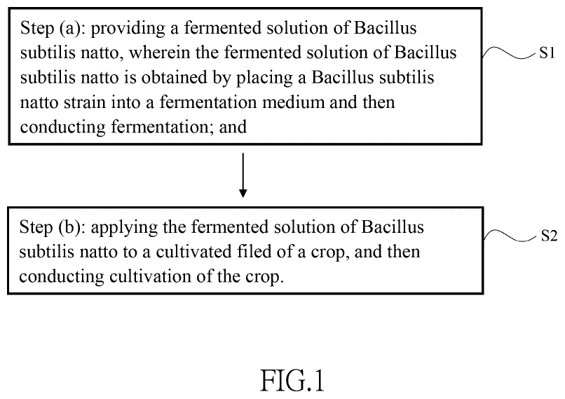

FIG. 2A is a photo showing the appearance of rice cultivated by the method described in Example 2.

FIG. 2B is a photo showing the appearance of rice cultivated by the method described in Comparative Example 2.

### DETAILED DESCRIPTION OF THE PREFERRED EMBODIMENTS

Hereinafter, several Examples and Comparative Examples are exemplified to illustrate the implementation of the present disclosure. One person skilled in the art can easily realize the advantages and effects of the present disclosure based on the following contents of the specification. It should be understood that the embodiments of the specification are used to illustratively explain the implementation of the present disclosure only, and are not intended to limit the scope of the present disclosure. Various modifications and variations could be made in order to practice or apply the present disclosure without departing from the spirit and scope of the invention.

### Example 1: Cultivating Method for Promoting Productivity of a Crop

Example 1 adopted paddy fields in Meinong District #Meinong Section 5265 in Kaohsiung as cultivated fields. The area of the cultivated fields was about 1454.876 square meters (m²), and rice variety named “Kaohsiung 147” was used as the crop for implementing the cultivating method for promoting productivity of a crop of the present disclosure. The rice cultivation described in Example 1 was the first cropping season of rice. The first cropping season generally means that the rice grows during February to June, with growing days (from transplanting rice seedings to harvesting) of approximately 120 days.

Specifically, a Bacillus subtilis natto strain (name: Bacillus subtilis natto NTU-18; depository number: BCRC 80390) was directly added into a fermentation medium, and then cultured in a shaker incubator at room temperature (about 25° C.) for 5 days of fermentation. After fermentation was completed, a fermented solution of Bacillus subtilis natto was obtained. The fermentation medium comprised water and a soybean meal (as a fermentation substrate), and based on a total weight of the fermentation medium, a content of the Bacillus subtilis natto strain was about 0.3 wt % and a content of the soybean meal was about 5 wt %.

On the other hand, after flooding and draining the cultivated fields for land preparation, 30 kilograms (kg) of tea seed pomace (in powder form) and 130 kg of animal fertilizers were added into the cultivated fields. Afterward, Kaohsiung 147 rice seedings were transplanted into the cultivated fields. Four days after transplanting the rice seedings, about 120 kg of organic fertilizers (main component: beer brewing dregs) and about 25 kg of potassium humate were added into the cultivated fields, and then about 120 liters (L) of the foresaid fermented solution of Bacillus subtilis natto was added into the cultivated fields, followed by proceeding subsequent rice cultivation.

The foresaid subsequent rice cultivation included adding about 140 kg of “#105 Biotec Organic Compound Fertilizer” (purchased from TAIWAN FERTILIZER CO., LTD.) into the cultivated fields about 10 days after transplanting the rice seedings, about 33 days after transplanting the rice seedings (i.e., topdressing) and about 55 days after transplanting the rice seedings (i.e., the first panicle fertilization), respectively; and adding about 40 kg of “#43““HeyWon”” Nitrophosphate Organic Compound Fertilizer” (purchased from TAIWAN FERTILIZER CO., LTD.) into the cultivated fields about 74 days after transplanting the rice seedings (i.e., the second panicle fertilization). At last, harvesting rice about 121 days after transplanting the rice seedings.

### Example 2: Cultivating Method for Promoting Productivity of a Crop

Example 2 adopted paddy fields in Changliang Village, Yuli Township #Yuli Township 155-6 area in Hualien as cultivated fields. The area of the cultivated fields was about 2230.809 m², and rice variety named “Kaohsiung 147” was used as the crop for implementing the cultivating method for promoting productivity of a crop of the present disclosure. The rice cultivation described in Example 2 was the second cropping season of rice. The second cropping season generally means that the rice grows during July to August or October to November, with growing days (from transplanting rice seedings to harvesting) of at least 100 days.

Specifically, by following the same procedures and conditions described in Example 1, a fermented solution of Bacillus subtilis natto was obtained. On the other hand, after flooding and draining the cultivated fields for land preparation, about 40 kg of potassium humate was added into the cultivated fields, and then about 160 L of the foresaid fermented solution of Bacillus subtilis natto was added into the cultivated fields, and the last about 200 kg of organic fertilizers (main component: beer brewing dregs) and about 30 kg of tea seed pomace (in powder form) were mixed and then added into the cultivated fields. Next, after three days, Kaohsiung 147 rice seedings were transplanted into the cultivated fields, followed by proceeding subsequent rice cultivation. At last, rice was harvested about 115 days after transplanting the rice seedings. It should be understood that during the implementation of Example 2, a severe typhoon struck, flooding the cultivated fields and blowing the rice stems by strong wind, thus affecting the rice productivity.

### Comparative Example 1: Traditional Cultivating Method

Comparative Example 1 adopted paddy fields in Meinong District #Meinong Section 5255 in Kaohsiung as cultivated fields. The area of the cultivated fields was about 26963.693 m², and rice variety named “Kaohsiung 147” was used as the crop for implementing the traditional cultivating method. Comparative Example 1 and Example 1 were implemented at the same time, thus the rice cultivation described in Comparative Example 1 was also the first cropping season of rice.

The cultivating procedures of Comparative Example 1 were almost the same as Example 1, and the main differences included that: Comparative Example 1 did not add fermented solution of Bacillus subtilis natto, tea seed pomace (in powder form), animal fertilizers and potassium humate into the cultivated fields. Except for the foresaid differences, Comparative Example 1 followed the same cultivating procedures described in Example 1, and harvested rice about 121 days after transplanting the rice seedings.

### Comparative Example 2: Traditional Cultivating Method

Comparative Example 2 adopted paddy fields in Changliang Village, Yuli Township #Yuli Township 155-6 area in Hualien as cultivated fields. The area of the cultivated fields was about 11348.029 m², and rice variety named “Kaohsiung 147” was used as the crop for implementing the traditional cultivating method. Comparative Example 2 and Example 2 were implemented at the same time in the same cultivated fields but different areas, thus the rice cultivation described in Comparative Example 2 was also the second cropping season of rice.

The cultivating procedures of Comparative Example 2 were almost the same as Example 2, and the main difference included that: Comparative Example 2 did not add fermented solution of Bacillus subtilis natto into the cultivated fields. Except for the foresaid difference, Comparative Example 2 followed the same cultivating procedures described in Example 2, and harvested rice about 115 days after transplanting the rice seedings.

### Analysis 1: Measurement of the Productivity of Crop

In analysis 1, after unhulled rice was taken from the harvested rice of Example 1, Example 2, Comparative Example 1 and Comparative Example 2, respectively, the unhulled rice of each group was weighted to obtain a wet weight of unhulled rice of each group, and then the wet weight of unhulled rice was divided by the area of cultivated fields of each group to obtain an average of wet weight of unhulled rice per square meter of each group. Then, the unhulled rice of each group was dried and then weighted to obtain a dry weight of unhulled rice of each group, and then the dry weight of unhulled rice was divided by the area of cultivated fields of each group to obtain an average of dry weight of unhulled rice per square meter of each group. The measured average wet weights or average dry weights of unhulled rice per square meter of Example 1, Example 2, Comparative Example 1 and Comparative Example 2 were listed in the following Table 1; meanwhile, Table 1 also listed the weight differences between Example 1 and Comparative Example 1 as well as the weight differences between Example 2 and Comparative Example 2. It should be understood that the land area unit commonly used in Taiwan is “fen”, 1 fen approximately equal to 969.917 m².

TABLE 1
The measured average wet weights, average dry weights and weight differences
of unhulled rice per square meter (per fen) of Example 1 (E1), Example
2 (E2), Comparative Example 1 (C1) and Comparative Example 2 (C2)

| | average wet weight | | average dry weight | |
|---|---|---|---|---|
| | of unhulled rice | | of unhulled rice | |
| | per square meter | weight | per square meter | weight |
| | (average wet | difference | (average dry | difference |
| | weight of unhulled | on wet | weight of unhulled | on dry |
| Groups | rice per fen) | weight | rice per fen) | weight |
| E1 | ~1.224 kg | About +42.6% | ~0.93 kg | About +54.7% |
| | (~1187 kg) | | (~902 kg) | |
| C1 | ~0.858 kg | — | ~0.601 kg | — |
| | (~832 kg) | | (~583 kg) | |
| E2 | ~0.892 kg | About +30% | ~0.652 kg | About +18.4% |
| | (~865 kg) | | (~606 kg) | |
| C2 | ~0.686 kg | — | ~0.528 kg | — |
| | (~665 kg) | | (~512 kg) | |

According to the results in Table 1, under that similar cultivating environment and conditions, the productivity of rice obtained by the method of Example 1 is obviously higher than that obtained by the method of Comparative Example 1; and the productivity of rice obtained by the method of Example 2 is also obviously higher than that obtained by the method of Comparative Example 2. Therefore, in comparison to the traditional cultivating method, the method provided by the present disclosure demonstrates the effect of promoting the productivity of the crop with an increment more than 18%.

### Analysis 2: Observation of the Appearance of Crop

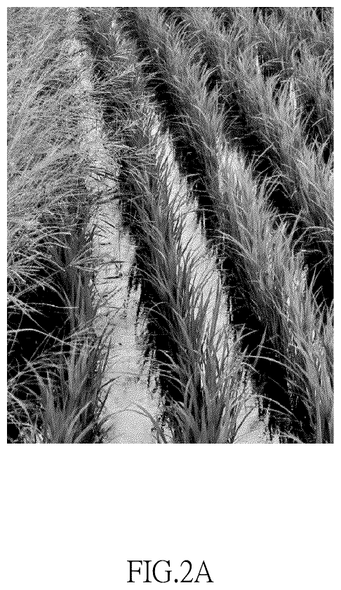

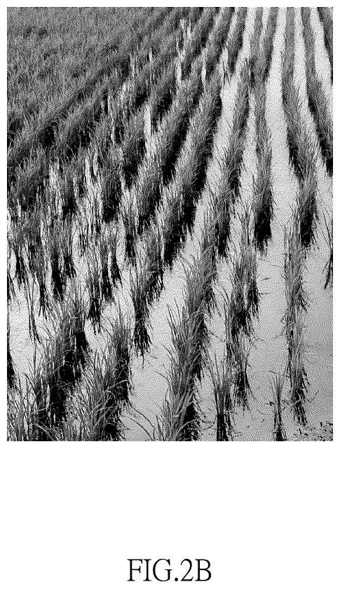

In analysis 2, during the rice cultivation of Example 2 and Comparative Example 2, photos of the rice appearance were taken by a camera 25 days after transplanting the rice seedings, which were shown in FIG. 2A and FIG. 2B.

According to FIG. 2A and FIG. 2B, in comparison to Comparative Example 2, Example 2 showed obviously more rice stems and grew more luxuriantly, which indicated that the rice in Example 2 would produce more rice ears in the subsequent heading stage, thereby obtaining a higher rice productivity.

In summary, by adding the fermented solution of Bacillus subtilis natto (obtained by subjecting Bacillus subtilis natto strain to fermentation) into cultivated fields of a crop during crop cultivation, the method for promoting productivity of a crop provided by the present disclosure demonstrates the effect of promoting crop productivity, thereby providing corresponding solutions to the challenges of the food crisis as well as commercial value.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cultivating method for promoting productivity of a crop, comprising the following steps:
step (a): providing a fermented solution of Bacillus subtilis natto, wherein the fermented solution of Bacillus subtilis natto is obtained by placing a Bacillus subtilis natto strain into a fermentation medium and then conducting fermentation; and
step (b): applying the fermented solution of Bacillus subtilis natto to a cultivated field of a crop, and then conducting cultivation of the crop.

2. The cultivating method as claimed in claim 1, wherein in the step (a), the Bacillus subtilis natto strain conducts fermentation in the fermentation medium at 25° C. to 35° C. for 5 days to 7 days to obtain the fermented solution of Bacillus subtilis natto.

3. The cultivating method as claimed in claim 1, wherein in the step (a), the fermentation medium comprises water and a fermentation substrate.

4. The cultivating method as claimed in claim 3, wherein the fermentation substrate comprises a soybean meal, a soybean, a protein powder or a combination thereof.

5. The cultivating method as claimed in claim 3, wherein based on a total weight of the fermentation medium, a content of the fermentation substrate is from 3 weight percent to 12 weight percent.

6. The cultivating method as claimed in claim 1, wherein in the step (a), the Bacillus subtilis natto strain is directly added into the fermentation medium for conducting fermentation to obtain the fermented solution of Bacillus subtilis natto; and based on a total weight of the fermentation medium, a content of the Bacillus subtilis natto strain is from 0.1 weight percent to 1 weight percent.

7. The cultivating method as claimed in claim 1, wherein in the step (b), the crop comprises a rice, a corn, a wheat, a soybean or a combination thereof.

8. The cultivating method as claimed in claim 1, wherein in the step (b), based on an area of the cultivated field per square meter, a usage amount of the fermented solution of Bacillus subtilis natto is from 60 milliliters to 150 milliliters.

9. The cultivating method as claimed in claim 1, wherein the step (b) further comprise a step of applying a fertilizer to the cultivated field.

10. The cultivating method as claimed in claim 1, wherein the step (b) further comprise a step of applying a tea seed pomace to the cultivated field.
